(19) United States
(12) Patent Application Publication
(10) Pub. No.: US 2012/0310655 A1
(43) Pub. Date: Dec. 6, 2012

(54) EXECUTING A BUSINESS PROCESS IN A BUSINESS REPORTING MANAGER

(76) Inventors: Andreas Vogel, Rauenberg (DE); Dominic Hehn, Speyer (DE); Steffen Maier, Mauer (DE); Andrei Tsoganov, Nussloch (DE)

(21) Appl. No.: 13/118,615

(22) Filed: May 31, 2011

(51) Int. Cl. G06Q 10/00

(52) U.S. Cl. 705/1.1

(57) ABSTRACT

Various embodiments of systems and methods for executing a business process in a business reporting manager are disclosed. At a first instance, a first business data to be extracted from an enterprise application is determined. A replication of the first business data is migrated to a migration repository to render the first message for data recovery. At a second instance, a second business data to be extracted from an enterprise application is determined. The first business data and the second business data are configured to execute the business process according to a data model associated with the business process. Based upon a modification in the data model, the second business data and the replication of the first business data is compiled to execute the business process according to the modified data model associated with the business process.

### FIELD

The field generally relates to computer systems, and more particularly to methods and systems for executing a business process in a business reporting manager.

### BACKGROUND

Life cycle management generally relates to managing product or service related processes starting from design, production, support and delivery of products or services. With the utilization of life cycle management, business organizations acquire an ability to perform essential business processes. Product or service life cycle goes through multiple stages. Parameters in which products or services exist may change over time, and must be managed as it moves through the succession of stages in life cycle management. Life cycle of a product or service includes a data warehouse for storing the business data at different stages. A data source in the data warehouse stores information about the business at a current state, and lacks a facility that provides information about the business at an earlier state. However, if there is a change in the business, process in the life cycle management may not be executed. There is a need for methods and systems for reloading as much of the data as possible and for developing the business information that is specific to the product or service.

### SUMMARY

Various embodiments of systems and methods for executing a business process in a business reporting manager are disclosed. In an embodiment, the business reporting manager receives a selection of a business process to be executed according to an associated business model. Based upon the business process, a first business data is extracted at a first instance, from an enterprise application associated with the business process. A replication of the first business data is migrated to a migration repository to render the first business data for data recovery. A second business data is extracted at a second instance from the enterprise application. Based upon a modification in the associated data model, a determination is made whether the second business data is sufficient to execute the business process. If the second business data is sufficient, the business process associated with the modified data model is executed. If the second business data is insufficient, the replication of the first business data is recovered from data recovery and compiled with the second business data to execute the business process.

In an embodiment, the first instance corresponds to an earlier instance and the first business data corresponds to a business data extracted at the earlier instance. The second instance corresponds to a current instance and the second business data corresponds to a business data extracted at the current instance.

In another embodiment, a replication of a first business data extracted at an earlier instance is migrated to the migration repository to render the first business data for data recovery at a current instance. Similarly, a replication of a second business data extracted at a current instance is migrated to the migration repository to render the second business data for data recovery at a future instance.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an overview of a system for executing a business process in a business reporting manager, according to an embodiment.

FIG. 2 is a block diagram illustrating an overview of a system for executing a business process in a business reporting manager, according to an embodiment.

FIGS. 3A and 3B are functional flow diagrams illustrating a method for executing a business process in a business reporting manager, according to an embodiment.

FIG. 4 is a process flow diagram illustrating a method for executing a business process in a business reporting manager, according to an embodiment.

FIG. 5 is a block diagram illustrating a computer system for executing a business process in a business reporting manager, according to an embodiment.

FIG. 6 is a block diagram illustrating an exemplary computer system, according to an embodiment.

### DETAILED DESCRIPTION

Embodiments of techniques for systems and methods for executing a business process in a business reporting manager are disclosed herein. At a first instance, a first business data to be extracted from an enterprise application is determined. A replication of the first business data is migrated to a migration repository to render the first message for data recovery. At a second instance, a second business data to be extracted from an enterprise application is determined. The first business data and the second business data are configured to execute the business process according to a data model associated with the business process. Based upon a modification in the data model, the second business data and the replication of the first business data is compiled to execute the business process according to the modified data model associated with the business process.

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

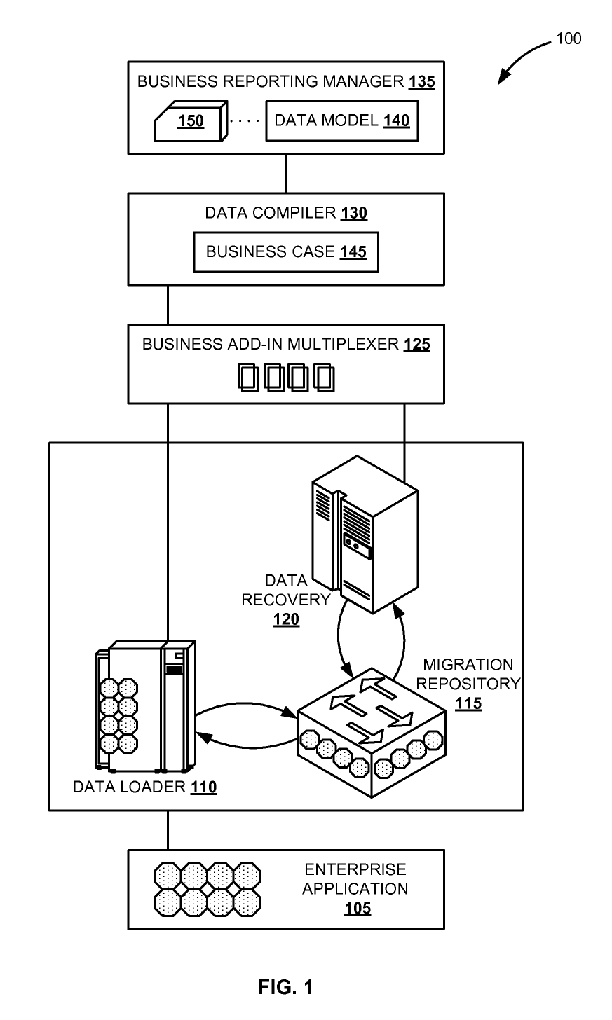

FIG. 1 is a block diagram illustrating an overview of a system for executing a business process in a business reporting manager, according to an embodiment. System 100 includes business reporting manager 135 which allows business process 150 to be executed according to data model 140, enterprise application 105, data loader 110, migration repository 115, data recovery 120, business add-in multiplexer 125, and data compiler 130. In an embodiment, business reporting manager 135 receives a selection of business process 150 to be executed according to associated data model 140. A business reporting manager 135 provides a fundamental access to tools that are required to carry out a business process on the computer along with authorization functions required. With the use of business reporting manager 135, business processes can be managed and monitored. A business process may be described as a structure of tasks or functions or a sequence of activities that are performed to produce a specific result (e.g. a service or a product). In an embodiment, attributes and parameters used to execute the business process may be described as business data. A data model 140 associated with the business process 150 and the business reporting manager 135 organizes and documents the business information for carrying out the business process. Data model 140 determines a structure of data that is required to execute business process 150. In an embodiment, data model 140 stores dimensions of one or more info-cubes.

A dimension represents a group of one or more enumerable business objects like products, people, financial elements, and time. For example, an email may be viewed in dimensions of a sender, a recipient, a subject, a date, a sent time, a received time, an email conversation, and the like. Some emails may also include custom dimensions, derived based upon contents found in the subject or body of the email. Dimensions like project type, and a team responsible for such a project type may be derived. An info-cube represents the information available to users in various dimensions. Each axis in the info-cube represents data from the dimensions such as sender, recipient, send time, subject of the email, and the like. Each axis may be described as a space along which the information is arranged. The axis includes a sequence of business entities that qualify as dimensions. The axis may also include some indicators about the order in which each dimension should be specified. All the axes together (for example x-axis, y-axis and z-axis) define the coordinates of the info-cube. An info-cube may also be described as an object that can function as a data-target and as a data source. The info-cube behaves as a self-contained dataset of a business-oriented environment. The info-cube is a quality of relational tables arranged according to a specific schema. For instance, an info-cube may contain a large fact-table surrounded by many dimension tables.

Business reporting manager 135 is associated with one or more enterprise applications (for e.g. 105). An enterprise application may be described as a business application, which includes a set of instructions that provide a user with enterprise tools that are required to accomplish a task. The instructions included in the enterprise applications may be used to assist business reporting manager 135 in executing business processes. Enterprise applications 105 may be deployed on various computer platforms across communication networks. Enterprise application 105 includes all the necessary instructions and information to execute business process 150.

In an embodiment, a user may select a business process 150 on a user interface of a computer, and business reporting manager 135 associated with the computer receives this selection. In an embodiment, business reporting manager 135 identifies one or more data models (e.g. 140) associated with business process 150. Based upon business process 150 and associated data model 140, an extractor extracts a first business data at a first instance from enterprise application 105 associated with business process 150. Data loader 110 is loaded with the extracted first business data at first instance. A data loader may be described as a function module that is administered in a central database. Data loader 110 houses the extracted first business data and makes the first business data accessible to all computer programs that use data loader 110. Data loader 110 migrates a replication of the first business data into migration repository 115, to render the first business data for data recovery 120. Migration repository 115 stores the replication of the first business data that migrated at scheduled instances from data loader 110, and makes the replication of the first business data available for data recovery 120. Data recovery 120 is a module that allows access to a secondary repository (e.g. migration repository 115) when normal data is not accessible. For instance, when there is a physical damage or logical damage to data loader 110, that prevents business data in data loader 110 from being accessed, data recovery 120 allows access to migration repository 115 that stores a replication of the business data replicated at scheduled intervals from data loader 110.

Data loader 110 also provides the first business data to data compiler 130 through business add-in multiplexer 125, to execute business process 150 at the first instance, according to data model 140 associated with business process 150. In an embodiment, business add-in multiplexer 125 identifies one or more business add-ins corresponding to business process 150 and provides the business add-ins to data compiler 130. Data compiler 130 compiles the first business data and the business add-ins to execute business process 150 according to data model 140.

Similar to the first message at the first instance, a second business data is extracted at a second instance from enterprise application 105. Data loader 110 is loaded with the extracted second business data. Data loader 110 migrates a replication of the second business data into migration repository 115, to render the second business data for data recovery. Data loader 110 also provides the second business data to data compiler 130 through business add-in multiplexer 125, to execute the business process at the second instance according to data model 140 associated with business process 150.

In an embodiment, data model 140 may have undergone a modification at the second instance. The second business data may not be sufficient for data compiler 130 to execute business process 150 according to the modification in data model 140. Based upon such a modification in data model 140, business add-in multiplexer 125 determines whether the second business data is sufficient to execute business process 150. If the second business data is insufficient to execute business process 150 according to the modification in data model 140, business add-in multiplexer 125 recovers the replication of the first business data stored in migration repository 115 through data recovery 120 and provides the first business data to data compiler 130 along with the second business data. Data compiler 130 compiles the first business data and the second business data, to execute business process 150 according to the modification in data model 140.

In an embodiment, the modification in data model 140 at a second instance is determined prior to extracting the second business data from enterprise application 105. In another embodiment, the modification of data model 140 is determined prior to executing the business process 150.

In an embodiment, migration repository 115 stores the first business data and the second business data in an arbitrary format, to render the first business data and the second business data for data recovery 120. Storing the first business data and the second business data in an arbitrary format may be appreciated while executing the first business data and the second business data. For instance, if the first business data is to be executed according to a format ‘A’ and the second business data is to be executed according to a format ‘B’, compiling the first business data and the second business data to execute business process 150 is achievable when the formats of both the business data are compatible. Hence, when the first business data and the second business data are stored in an arbitrary format, the compatibility of the formats does not cause any effect in executing business process 150. For instance, storing a HyperText Markup Language (HTML) business data in an arbitrary format is appreciated when the HTML business data has to be complied with an Extensible Markup Language (XML) business data, which is in a different format. It will be appreciated that message formats are not limited to HTML or XML formats, and may include eXtensible HyperText Markup Language (XHTML), Dynamic HyperText Markup Language (DHTML), Hypertext PreProcessor (PHP), cascading type sheets (CSS), JavaScript, and the like.

In an embodiment, the first instance corresponds to an earlier instance and the first business data corresponds to a business data extracted at the earlier instance. The second instance corresponds to a current instance and the second business data corresponds to a business data extracted at the current instance. For instance, on the 1^{st} day of January 2012, a business data to be extracted from enterprise application 105 is determined. A replication of the business data extracted on the 1^{st} day of January 2012 is migrated to migration repository 115. On the 1^{st} day of February 2012, a business data to be extracted from enterprise application 105 is determined. Based upon a modification in data model 140, that may have occurred between the 1^{st} day of January 2012 and 1^{st} day of February 2012, the business data extracted on the 1^{st} day of February 2012 may not be sufficient and there may be a need for an earlier business data for executing business process 150. This earlier business data is extracted from migration repository 115 that includes the replication of the business data extracted on the 1^{st} day of January 2012. The business data extracted on the 1^{st} of January 2012 and the business data extracted on the 1^{st} of February 2012 are compiled by data compiler 130 to execute business process 150 according to the modification in data model 140.

The replication of a first business data extracted at the earlier instance is migrated to migration repository 115 to render the first business data for data recovery 120 at a current instance. Similarly, the replication of a second business data extracted at the current instance is migrated to migration repository 115 to render the second business data for data recovery 120 at a future instance. In an embodiment, the replications of each of the business data are stored in migration repository 115 along with an identifier to identify the corresponding instances at which the data was replicated. In another embodiment, the migration of each business data is performed at scheduled instances. For instance, a replication of the business data occurs on the first day of every month. The replication of the business data of a previous month becomes the business data at an earlier instance and the replication of the business data of a current month becomes the business data at a current instance.

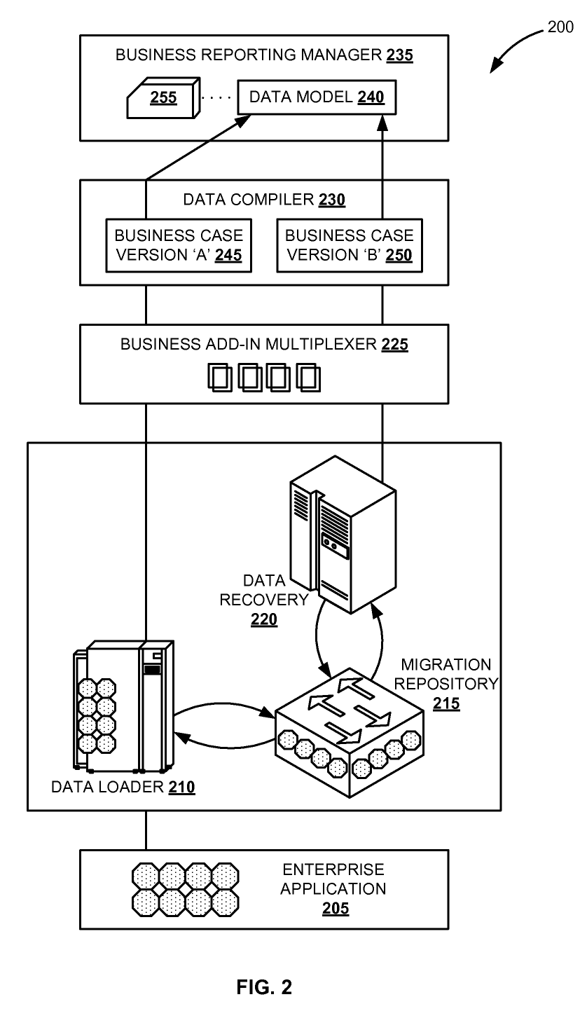

FIG. 2 is a block diagram illustrating an overview of a system for executing a business process in a business reporting manager, according to an embodiment. System 200 includes business reporting manager 235 which allows business process 255 to be executed according to data model 240, enterprise application 205, data loader 210, migration repository 215, data recovery 220, business add-in multiplexer 225, and data compiler 230. The process of extracting a first business data and a second business data, the process of replicating the business data, and the process of compiling the first business data and the second business data are as explained in the description of FIG. 1.

According to FIG. 2, data compiler 230 generates a business case for every compilation of a business data and corresponding business add-ins. A business case may be described as a specific business need for initiating the task of executing the business process. A business case may result from one or more parameters including a context, one or more deliverables, required one or more resources, required one or more processes, deliverables schedule, and the like, all specified for the business case. For instance, a business case may result from executing a business process of ‘running an expense report’ on the ‘first day’ of ‘every month’, for the month of April 2012. Also, let the replication of the business data at data loader 210 be scheduled on the 2^{nd} day of every month.

On the 1^{st} of January 2012, a first business data is extracted and loaded to data loader 210. Data loader 210 migrates a replication of the first business data to migration repository 215 on the 2^{nd} of January 2012. On the 1^{st} of February 2012, a second business data is extracted and loaded to data loader 210. Data loader 210 migrates a replication of the second business data to migration repository 215 on the 2^{nd} of February 2012. On the 1^{st} of March 2012, a third business data is extracted and loaded to data loader 210. Data loader 210 migrates a replication of the third business data to migration repository 215 on the 2^{nd} of March 2012. On the 1^{st} of April 2012, a fourth business data is extracted and loaded to data loader 210. Also, on the 1^{st} of April 2012, the business process has to be executed (as specified for the business case).

On the 15^{th} of March 2012, data model 240 is updated to ease use-interactions with business reporting manager 235. Since a fourth business data is extracted on the 1^{st} of April 2012, after the modification to data model 240 on the 15^{th} March 2012, there may be a need of one or more business data extracted for data model 240 before the modification. This need is determined by business add-in multiplexer 225, which extracts a replication of the third business data stored in migration repository 215, from data recovery 220. This third business data is compiled with the fourth business data and the necessary business add-ins identified by business add-in multiplexer 225, by data compiler 230 and a business case version ‘B’ 250 is created. The business process associated with the modified data model 240 may be executed utilizing the business case version ‘B’ 250.

In an embodiment, there may be a need for a modification that may have occurred on the 15^{th} of February 2012. Here, data compiler 230 may compile business case version ‘A’ 245 on the 1^{st} of March 2012 after the modification to data model 240 on the 15^{th} of February 2012. Now, to execute business process 255 according to data model 240 that was modified on 15 Mar. 2012, business case version ‘B’ 250 and business case version ‘A’ 245 may be compiled by data compiler 230.

In an embodiment, business process 255 may have been executed on the 1^{st} of February 2012, according to another business case. Business process 255 need not wait to consider business case version ‘A’ 245 and business case version ‘B’ 250 until the resultant business case is specified.

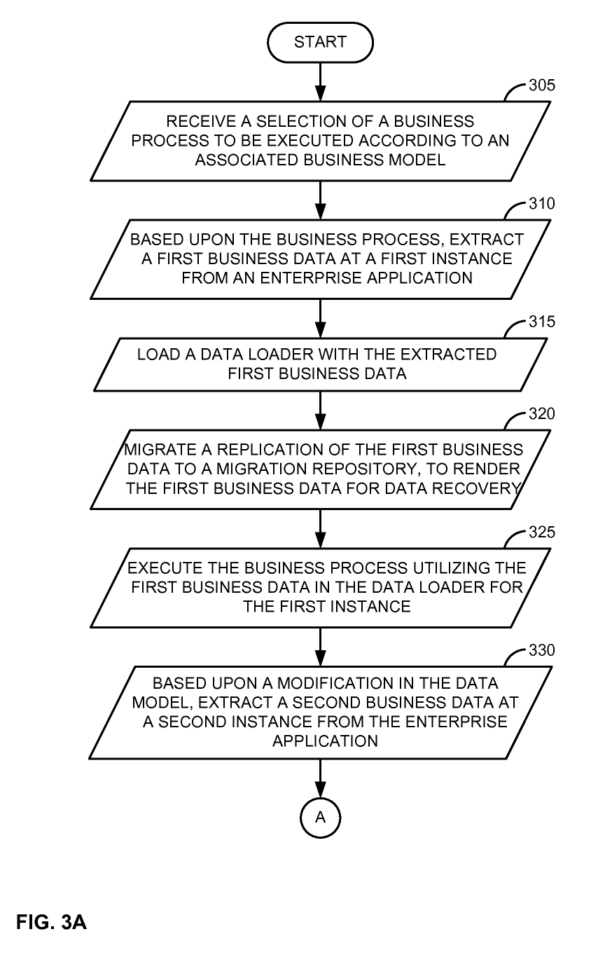

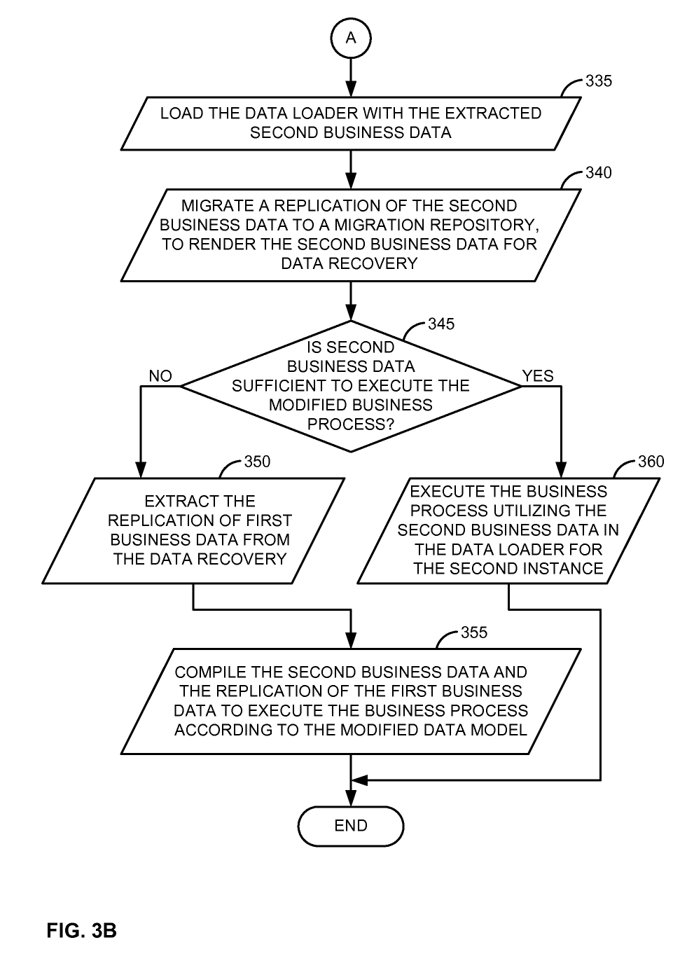

FIGS. 3A and 3B are functional flow diagrams illustrating a method for executing a business process in a business reporting manager, according to an embodiment. In functional block 305, a selection of a business process to be executed according to an associated business model is received. In an embodiment, a user may select a business process on a user interface of a computer and business reporting manager associated with the computer receives this selection. In functional block 310, based upon the selected business process, a first business data is extracted from an enterprise application associated with the business process, at a first instance. In functional block 315, a data loader is loaded with the extracted first business data. In functional block 320, the data loader migrates a replication of the first business data to a migration repository, to render the first business data for data recovery. In functional block 325, the business process is executed utilizing the first business data in the data loader, for the first instance. In an embodiment, a multiplexer may be utilized as a medium between the data loader and a data compiler, which executes the business process.

In functional block 330, based upon a modification in the data model associated with the business process at a second instance, a second business data is extracted at the second instance from the enterprise application. In an embodiment, a data extractor may be utilized to extract the first business data and the second business data from the enterprise application associated with the business process. In functional block 335, the data loader is loaded with the extracted second business data. In functional block 340, the data loader migrates a replication of the second business data to the migration repository, to render the second business data for data recovery.

In an embodiment, the second business data may not be sufficient to execute the business process associated with the modified data model. In such cases, the replication of the first business data may be utilized to execute the business process at the second instance. In decision block 345, a determination of whether the second business data is sufficient to execute the business process associated with the modified data model, is established. In an embodiment, the modified data model may transform the business process into a modified business process. If the second business data is sufficient to execute the modified business process, the process proceeds to functional block 360. In functional block 360, the business process is executed utilizing the second business data in the data loader for, the second instance.

If the second business data is insufficient to execute the modified business process, the process proceeds to functional block 350. In functional block 350, the replication of the first business data is extracted from the data recovery. Further, in functional block 355, the second business data and the replication of the first business data is compiled, to execute the business process according to the modified data model (e.g. the modified business process) at the second instance. In an embodiment, the multiplexer may be utilized as a medium between the data loader and a data compiler, which executes the business process.

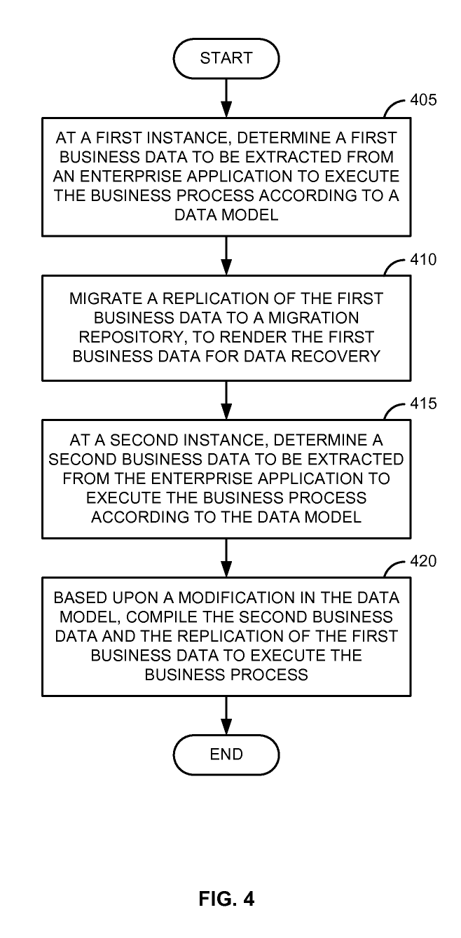

FIG. 4 is a process flow diagram illustrating a method for executing a business process in a business reporting manager, according to an embodiment. In process block 405, at a first instance, a first business data to be extracted from an enterprise application is determined. In process block 410, a replication of the first business data is migrated to a migration repository to render the first message for data recovery. In process block 415, at a second instance, a second business data to be extracted from an enterprise application is determined. The first business data and the second business data are configured to execute the business process according to a data model associated with the business process. In process block 420, based upon a modification in the data model, the second business data and the replication of the first business data is compiled to execute the business process according to the modified data model associated with the business process.

In an embodiment, the first instance corresponds to an earlier instance and the first business data corresponds to a business data extracted at the earlier instance. The second instance corresponds to a current instance and the second business data corresponds to a business data extracted at the current instance. Hence, when a modification of the data model occurs during a current instance, the business data of the previous instance is available at the data recovery, and may be utilized to execute the business process associated with the modified data model.

In another embodiment, a replication of a first business data extracted at an earlier instance is migrated to the migration repository to render the first business data for data recovery at a current instance. Similarly, a replication of a second business data extracted at a current instance is migrated to the migration repository to render the second business data for data recovery at a future instance.

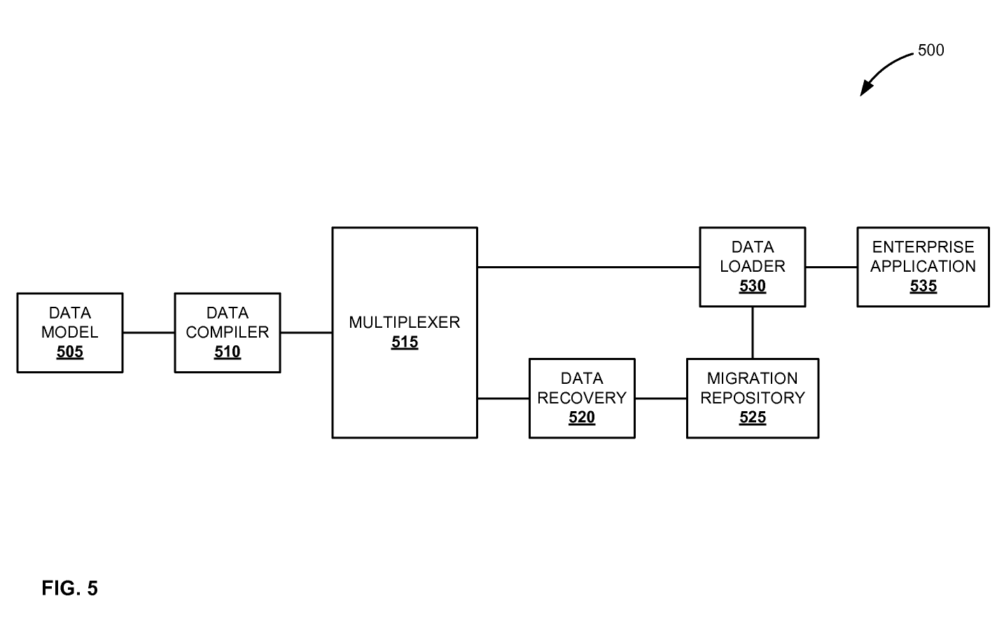

FIG. 5 is a block diagram illustrating a computer system for executing a business process in a business reporting manager, according to an embodiment. In an embodiment, computer system 500 includes data model 505, data compiler 510, multiplexer 515, data recovery 520, migration repository 525, data loader 530, and enterprise application 535. In an embodiment, computer system 500 includes a processor and one or more memory elements. In another embodiment, data model 505 is comprised in the business reporting manager.

In an embodiment, data model 505 is in communication with data compiler 510. Data compiler 510 is in communication with multiplexer 515. Multiplexer 515 is in communication with data loader 530 and data recovery 520. Migration repository 525 is in communication with data loader 530 and data recovery 520. Enterprise application 535 is in communication with data loader 530. In an embodiment, an extractor is in communication with data loader 530 and enterprise application 535.

In an embodiment, a user may select a business process to be executed in a business reporting manager. The business process may be selected on a user interface of a computer, and an associated processor of the business reporting manager receives this selection. Based upon the selected business process, the extractor extracts a first business data at a first instance, from enterprise application 535. Data loader 530 is loaded with the extracted first business data. At the first instance, data loader 530 migrates a replication of the first business data to migration repository 525, to render the first business data for data recovery 520. Multiplexer 515 is utilized as a medium between data loader 530 and data compiler 510. In an embodiment, multiplexer 515 determines one or more business add-ins corresponding to the business process and compiles with the corresponding business data to execute the business process. Data compiler 510 compiles the identified business add-ins along with the first business data to execute the business process.

Similarly, the extractor extracts a second business data at a second instance from enterprise application 535. At the second instance, data loader 530 is loaded with the extracted second business data. At the second instance, data loader 530 migrates a replication of the second business data to migration repository 525, to render the second business data for data recovery 520. In an embodiment, data model 505 may be modified to execute the business process. Based upon the modification in data model 505 associated with the business process at the second instance, extractor extracts the second business data at the second instance. Multiplexer 515 is responsible for determining if the second business data is sufficient to execute the business process associated with the modified data model. If the second business data is sufficient, the business process is executed utilizing the second business data in data loader 530, at the second instance.

If the second business data is insufficient to execute the business process associated with the modified data model, multiplexer 515 extracts the replication of the first business data from data recovery 520. Data compiler 510 compiles the second business data and the replication of the first business data, to execute the business process associated with the modified data model. In an embodiment, compiling the second business data includes identifying and extracting a replication of a business data corresponding to an earlier instance present in the migration repository and compiling the replication of the business data corresponding to the earlier instance and a business data corresponding to a current instance to execute the business process.

In an embodiment, the first instance corresponds to an earlier instance and the first business data corresponds to a business data extracted at the earlier instance. Similarly, the second instance corresponds to a current instance and the second business data corresponds to a business data extracted at a current instance. In an embodiment, the replication of the first business data and the second business data may be scheduled. In another embodiment, the replication of the business data is stored in migration repository 525 along with an identifier to identify the instance at which the business data is replicated. In yet another embodiment, the first replicated business data and the second replicated business data are stored in an arbitrary format.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

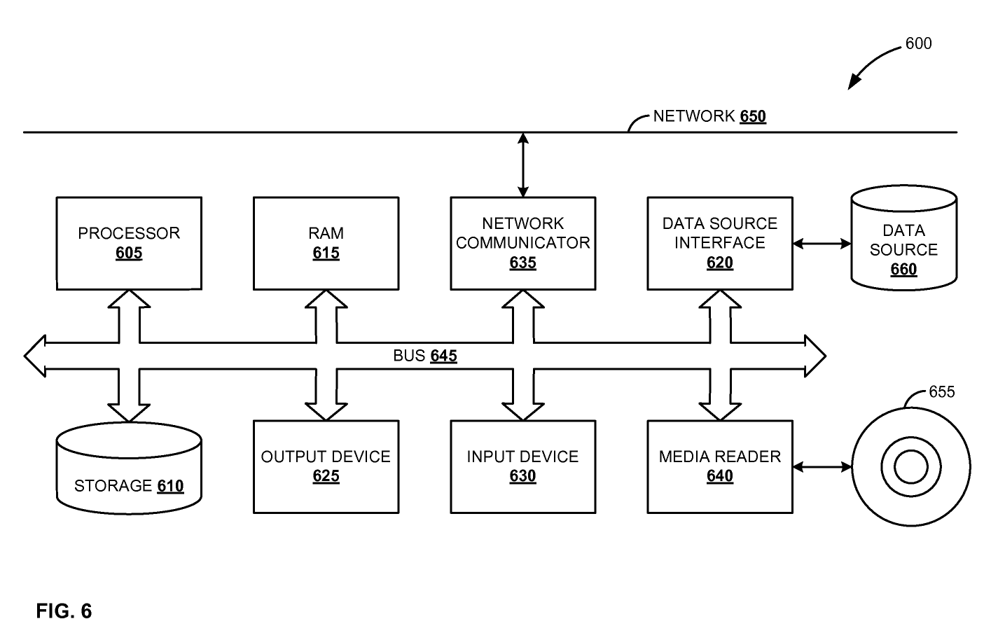

FIG. 6 is a block diagram of an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, continuation servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transaction, hierarchical, multi-dimensional (e.g., OLAP), object oriented databases, and the like. Further data sources include tabular data (e.g., spreadsheets, delimited text files), data tagged with a markup language (e.g., XML data), transaction data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer-implemented method to execute a business process in a business reporting manager, the method comprising:
at a first instance, determining a first business data to be extracted from an enterprise application to execute the business process according to a data model;
migrating a replication of the first business data to a migration repository, to render the first business data for data recovery;
at a second instance, determining a second business data to be extracted from the enterprise application to execute the business process according to the data model; and
based upon a modification in the data model, compiling the second business data and the replication of the first business data to execute the business process.

2. The computer implemented method of claim 1 further comprising:
identifying one or more business add-ins required to execute the business process; and
compiling the business add-ins and a corresponding business data to execute the business process at a corresponding instance.

3. The computer implemented method of claim 1 further comprising: migrating a replication of the second business data to a migration repository, to render the second business data for data recovery.

4. The computer implemented method of claim 1, wherein the first instance corresponds to an earlier instance and the first business data corresponds to a business data at the earlier instance.

5. The computer implemented method of claim 1, wherein the replication of a business data is stored in the migration repository along with an identifier to identify the instance at which the business data is replicated.

6. The computer implemented method of claim 1, wherein the second instance corresponds to a current instance and the second business data corresponds to a business data at the current instance.

7. The computer implemented method of claim 1, wherein compiling the second business data comprises:
identifying and extracting a replication of a business data corresponding to an earlier instance present in the migration repository; and
compiling the replication of the business data corresponding to the earlier instance and a business data corresponding to a current instance to execute the business process.

8. The computer implemented method of claim 1, wherein the replication of the first business data and the replication of the second business data are stored in an arbitrary format, to render the first business data and the second business data for data recovery.

9. The computer implemented method of claim 1, wherein compiling the second business data comprises: generating a business case based upon the business add-ins, the second business data and the replication of the first business data.

10. The computer implemented method of claim 1, wherein executing the business process according to a modification in the data model comprises:
generating a first business case and a second business case based upon one or more parameters; and
compiling the first business case and the second business case to execute the business process according to the modification in the data model.

11. The computer implemented method of claim 1, wherein migrating a replication of the first business data and the second business data comprises scheduling the replication of the first business data.

12. A computer system to execute a business process in a business reporting manager, comprising:
a processor operable to read and execute instructions stored in one or more memory elements; and
the one or more memory elements storing instructions related to:
a data loader configured to determine a first message to be extracted from an enterprise application at a first instance, to execute the business process according to a data model, and a second message to be extracted from the enterprise application at a second instance, to execute the business process according to the data model,
a migration repository configured to store a replication of the first business data and a replication of the second business data for data recovery;
a data compiler configured to determine a modification in the data model associated with the business application, and compile the second business data and the replication of the first business data to execute the business process.

13. The computer system of claim 12, further comprising:
a multiplexer configured to identify one or more business add-ins required to execute the business process and to determine whether the second business data is sufficient to execute the business process.

14. The computer system of claim 12, wherein the migration repository is configured to store the replication of the first business data and the replication of the second business data along with an identifier to identify the instance at which the business data is replicated.

15. The computer system of claim 12, wherein the migration repository is configured to store the replication of the first business data and the replication of the second business data in an arbitrary format, to render the first business data and the second business data for data recovery.

16. The computer system of claim 12, wherein the data compiler is configured to generate a business case based upon the business add-ins, the second business data and the replication of the first business data.

17. An article of manufacture including a computer readable storage medium to tangibly store instructions, which when executed by a computer, cause the computer to:
at a first instance, determine a first business data to be extracted from an enterprise application to execute a business process according to a data model;
migrate a replication of the first business data to a migration repository, to render the first business data for data recovery;
at a second instance, determine a second business data to be extracted from the enterprise application to execute the business process according to the data model; and
based upon a modification in the data model, compile the second business data and the replication of the first business data to execute the business process.

18. The article of manufacture of claim 17 further comprising instruction to:
identify one or more business add-ins required to execute the business process; and
compile the business add-ins and a corresponding business data to execute the business process at a corresponding instance.

19. The article of manufacture of claim 17 further comprising instructions to: migrate a replication of the second business data to a migration repository, to render the second business data for data recovery.

20. The article of manufacture of claim 17, wherein executing the business process according to a modification in the data model comprises:
generating a first business case and a second business case based upon one or more parameters; and
compiling the first business case and the second business case to execute the business process according to the modification in the data model.
